(19) United States
(12) Patent Application Publication
(10) Pub. No.: US 2023/0291131 A1
(43) Pub. Date: Sep. 14, 2023

(54) INSULATION PIERCING CONNECTOR

(71) Applicant: YUYAO JERA LINE CO., LTD., Ningbo (CN)

(72) Inventor: MAKSIM KRAETCKII, Ningbo (CN)

(21) Appl. No.: 18/319,273

(22) Filed: May 17, 2023

(30) Foreign Application Priority Data
Apr. 11, 2023 (CN) 202320793458.1

(51) Int. Cl. H01R 4/2454

(52) U.S. Cl. CPC H01R 4/2454

(57) ABSTRACT

The disclosure provides an insulation piercing connector, where two clamp bodies are arranged opposite to each other, a first clamp body comprises a conductive piercing structure, two piercing portions of the piercing structure are covered by an elastic sealing portion, and two cables are clamped between the two clamp bodies; the two clamp bodies are respectively mounted on a fastener so as to be configured such that after the fastener is fastened, the two clamp bodies have a clamping force to clamp the cables, so that the piercing portions pass through elastic sealing portions and insulation layers of the cables and then are conductively connected with conductors of the cables; and due to arrangement of the elastic sealing portions, gaps between the elastic sealing portions and the insulation layers of the cables are filled and sealed, so that ingress protection rating can reach IP-68 after mounting of the branch clamp.

### TECHNICAL FIELD

The present invention pertains to the technical field of electrically conductive cable connectors, and specifically pertain to an insulation piercing connector.

### BACKGROUND

In power grids for photovoltaic systems, for underground and overhead environments and for floors of high-rise buildings, conductive cables often need to be connected in parallel to branches line or grounded, but insulation piercing connectors (also known as branch clamps, insulation piercing branch clamps or conductive cable branch clamps) are often used to electrically connect a main electrical cable to one end of an electrical conductor of a tap line. In the prior art, patent publication No. CN204720567U discloses a branch clamp which has a piercing blade protruding from a clamping surface of a clamp body; however, when two oppositely arranged clamp bodies clamp a conductive cable, the piercing blade penetrates an insulation layer of the cable and comes into contact with an underlying conductor, so that the piercing blade is electrically connected with the conductor; different cables have the insulation layers of different thicknesses, so that after the piercing blade penetrates the insulation layer of the cable and comes into contact with the underlying conductor, a gap still exists between the clamping surface with the piercing blade and the insulation layer of the cable, so that the branch clamp cannot play a sealing role. When water or vapor comes into contact with the conductor in the gap, such contact can easily cause short circuit or safety accidents. Therefore, it is in urgent need to solve this defect.

### SUMMARY

The purpose of the present invention is to provide an insulation piercing connector designed to solve the above-mentioned technical deficiency.

An insulation piercing connector according to the present invention comprises:
a first clamp body and a second clamp body, where the first clamp body and the second clamp body are arranged opposite to each other, the first clamp body comprises a conductive piercing structure, a first elastic sealing portion and a second elastic sealing portion, the conductive piercing structure is provided with a first piercing portion and a second piercing portion which extend toward the direction of the second clamp body, the first piercing portion is covered by the first elastic sealing portion, and the second piercing portion is covered by the second elastic sealing portion; and
a fastener, where the first clamp body and the second clamp body are respectively mounted on the fastener to be configured such that after the fastener is fastened, both the first clamp body and the second clamp body have a clamping force.

According to the insulation piercing connector described above, the first clamp body further comprises an elastic insulator that enables the conductive piercing structure to be at least partially covered, the first elastic sealing portion and the second elastic sealing portion are respectively formed on the elastic insulator, the elastic insulator is provided with a first clamping position, the first elastic sealing portion is located at the first clamping position, the second clamp body is provided with a second clamping position, the first clamping position is arranged opposite to the second clamping position, the first elastic sealing portion comprises an elastic clamping block arranged protruding from the first clamping position, and a sharp portion of the first piercing portion is close to a cable contact surface of the elastic clamping block.

According to the insulation piercing connector described above, the second clamp is provided with the second clamping position, the first clamping position is provided with an elastic sealing ring surrounding the elastic clamping block, a height of the elastic clamping block is a, a height of the elastic sealing ring is b, and a is greater than or equal to b; and the cable contact surfaces of the elastic clamping block, the elastic sealing ring and the second clamping position are all arc-shaped concave surfaces.

According to the insulation piercing connector described above, the elastic insulator is provided with a third clamping position, the second elastic sealing portion is located at the third clamping position, the second elastic sealing portion is provided with a cable clamping sleeve arranged protruding from the third clamping position, the cable clamping sleeve is made of an elastic material, and a sharp portion of the second piercing portion is close to an inner wall surface of the cable clamping sleeve.

According to the insulation piercing connector described above, at least one convex ring is formed on an inner wall of the cable clamping sleeve, and both ends of the cable clamping sleeve are arranged closed and open respectively.

According to the insulation piercing connector described above, the insulation piercing connector further comprises a piercing aid, the second clamp body is provided with a fourth clamping position, the third clamping position and the fourth clamping position are arranged opposite to each other, and the piercing aid is at least partially located between the cable clamping sleeve and the fourth clamping position.

According to the insulation piercing connector described above, the piercing aid comprises an aid body and a sliding body formed on the aid body, the aid body is located between the cable clamping sleeve and the fourth clamping position, and the sliding body is slidingly connected to the first clamp body such that the piercing aid can slide in an axial direction of the fastener.

According to the insulation piercing connector described above, the conductive piercing structure comprises two conductive piercing pieces which are arranged apart from each other, and the conductive piercing pieces each are provided with the first piercing portion and the second piercing portion.

According to the insulation piercing connector described above, the elastic insulator is provided with a trapezoidal channel, the sliding body has a trapezoidal cross section, and the sliding body is placed in the trapezoidal channel.

According to the insulation piercing connector described above, a housing is provided with a first guide portion, and the second clamp body is provided with a second guide portion; the first guide portion is provided with an elongated guide groove arranged parallel to an axis of the fastener, and the second guide portion is arranged in the elongated guide groove, or the second guide portion is provided with an elongated guide groove arranged parallel to the axis of the fastener, and the first guide portion is arranged in the elongated guide groove.

According to the insulation piercing connector described above, the first clamp body and the second clamp body are respectively provided with a perforation for the fastener to pass through, the perforation of the first clamp body is threadedly connected with a threaded section of the fastener, a head portion of the fastener is seized with a seizing portion on the first clamp body to limit rotation of the fastener, a tail portion of the fastener is threadedly connected to a limiting member, the limiting member is in limiting fit with the second clamp body to be configured to operate the limiting member to drive the limiting member to displace the second clamp body in the direction of the first clamp body so that the first clamp body and the second clamp body are in a clamping state having the clamping force, and the fastener is in a fastened state.

According to the insulation piercing connector described above, the insulation piercing connector further comprises a first cable and a second cable, the first cable and the second cable are located between the first clamp body and the second clamp body, the first piercing portion positionally corresponds to the first cable, and the second piercing portion positionally corresponds to the second cable; the first cable and the second cable are clamped by means of the clamping force of the first clamp body and the second clamp body, so that the first piercing portion passes through the first sealing portion and an insulation layer of the first cable under the action of the clamping force and then interferes with an elongated conductor of the first cable to form conductive connection thereto, and the first sealing portion seals a periphery of an exposed portion of the first piercing portion; and the second piercing portion passes through the second sealing portion and an insulation layer of the second cable under the action of the clamping force and then interferes with an elongated conductor of the second cable to form conductive connection thereto, and the second sealing portion seals a periphery of an exposed portion of the second piercing portion.

The insulation piercing connector according to the present invention has the following beneficial effects:
1. The piercing portions are covered by the elastic sealing portions, and the elastic sealing portions are made of the elastic material by injection molding and encapsulation; the piercing portions are also close to the cable contact surfaces of the elastic sealing portions; after the fastener is operated, both the first clamp body and the second clamp body have a clamping force to clamp the first cable and the second cable, and after the first piercing portion passes through the first elastic sealing portion and the insulation layer of the first cable under the action of the clamping force, the first piercing portion interferes with the elongated conductor of the first cable to form conductive connection, and the first elastic sealing portion seals the periphery of the exposed portion (exposed to the gap between the cable contact surface and an outer wall of the insulation layer of the cable) of the first piercing portion; and after the second piercing portion passes through the second elastic sealing portion and the insulation layer of the second cable under the action of the clamping force, the second piercing portion interferes with the elongated conductor of the second cable to form conductive connection, and the second elastic sealing portion seals the periphery of the exposed portion (exposed to the gap between the cable contact surface and the outer wall of the insulation layer of the cable) of the second piercing portion, thus preventing water or vapor from penetrating into the conductor of the cable through the gap between the cable contact surface and the outer wall of the insulation layer of the cable, so as to achieve safe and reliable use of the branch clamp.
2. The elastic sealing ring and the elastic clamping block are arranged to realize double sealing of the periphery of the exposed portion, and the cable clamping sleeve wrapping the cable and the elastic sealing portion on the periphery of the exposed portion also realize double sealing, so that after the branch clamp is mounted, the ingress protection rating of the branch clamp of the present invention can reach IP-68 without use of any waterproof glue.
3. When the first clamp body and the second clamp body clamp the cable, the aid body of the piercing aid assists in squeezing the elastic cable clamping sleeve, so as to assist the sharp portion of the second piercing portion to smoothly pass through the inner wall surface of the cable clamping sleeve and the insulation layer of the second cable and then come into contact with and conductively connect with the conductor of the second cable, so that the aid body increases the clamping force of the first clamp body and the second clamp body on the second cable, improving service performance of the branch clamp.
4. The relative displacement between the first clamp body and the second clamp body is limited by the elongated guide groove to prevent rotation of the two clamp bodies during operation of the fastener, so that the first clamp body and the second clamp body can be separated or closed by moving relative to each other.

### BRIEF DESCRIPTION OF THE DRAWINGS

FIG. 1 is an overall structural schematic diagram (I) of a branch clamp;

FIG. 2 is a section view (I) of the branch clamp;

FIG. 3 is a section view (II) of the branch clamp;

FIG. 4 is a section view (III) of the branch clamp;

FIG. 5 is an overall structural schematic diagram (II) of the branch clamp;

FIG. 6 is an overall structural schematic diagram (III) of the branch clamp;

FIG. 7 is an overall structural schematic diagram (IV) of the branch clamp;

FIG. 8 is an overall structural schematic diagram (V) of the branch clamp; and

FIG. 9 is a top view of the branch clamp.

### REFERENCE NUMERALS IN THE DRAWINGS

first clamp body 1, perforation 10, conductive piercing structure 11, conductive piercing piece 111, first piercing portion 112, second piercing portion 113, sharp portion 114, elastic insulator 12, first clamping position 120, second clamping position 21, first elastic sealing portion 122, second elastic sealing portion 123, first guide portion 124, elastic clamping block 125, elastic sealing ring 126, cable clamping sleeve 127, elongated guide groove 128, trapezoidal channel 129, opening 130, convex ring 131 and housing 13;
second clamp body 2, third clamping position 121, fourth clamping position 22 and second guide portion 23;
fastener 3, limiting portion 30, limiting ring 31, limiting sleeve 32 and limiting step 321;
piercing aid 4, aid body 41, sliding body 42 and third guide portion 43; and
first cable 5, second cable 6, and positioning sleeve 7.

### DESCRIPTION OF THE EMBODIMENTS

The technical schemes of the embodiments of the present invention will be described clearly and completely below with reference to the accompanying drawings in the embodiments of the present invention, and it is obvious that the embodiments described are only some, instead of all, of the embodiments of the present invention. All other embodiments obtained by those of ordinary skill in the art based on the embodiments of the present invention fall within the scope of the present invention.

### EMBODIMENTS

The insulation piercing connector (also known as branch clamp, insulation piercing branch clamp or conductive cable branch clamp) according to the present embodiment has the following structure.

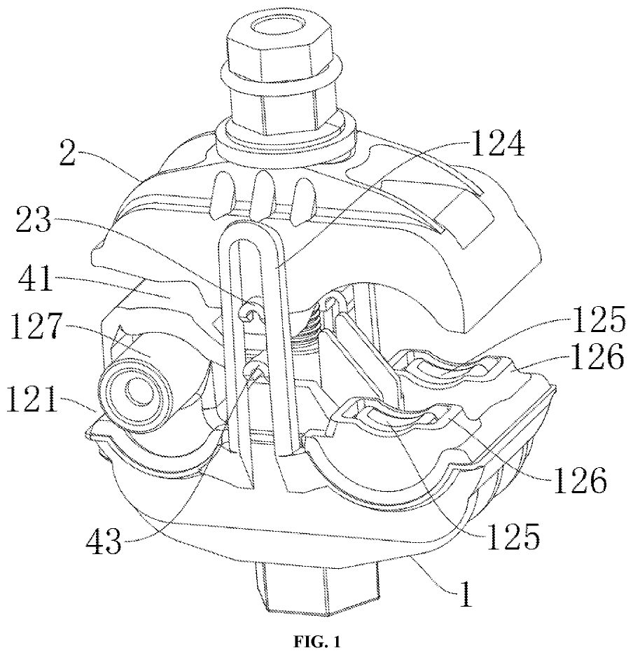

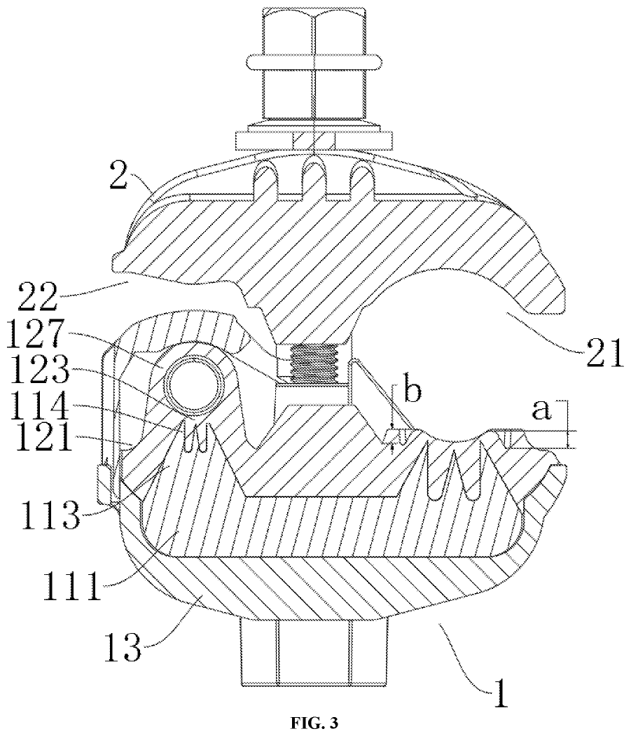

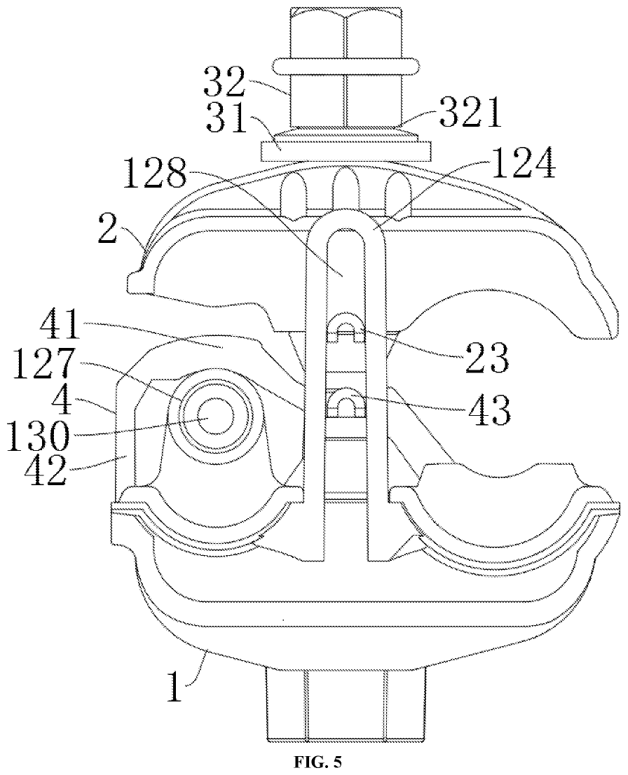

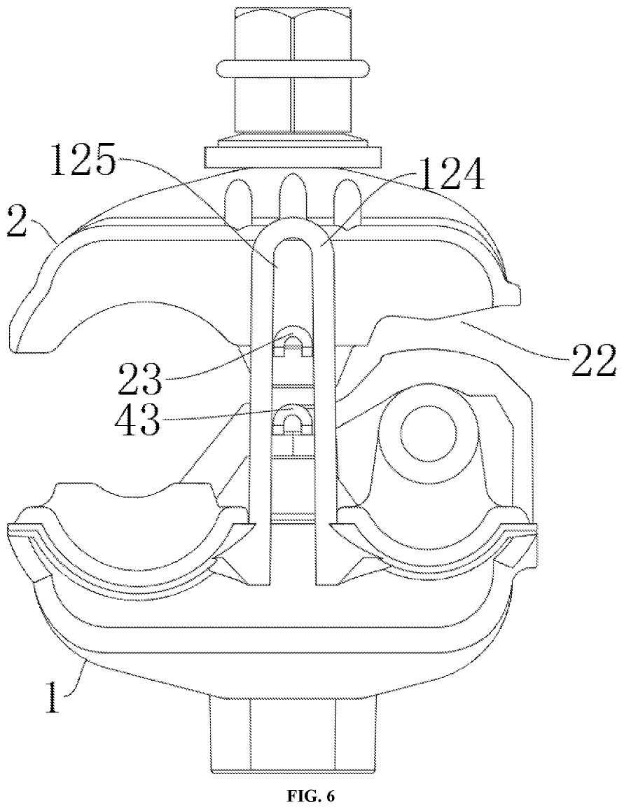

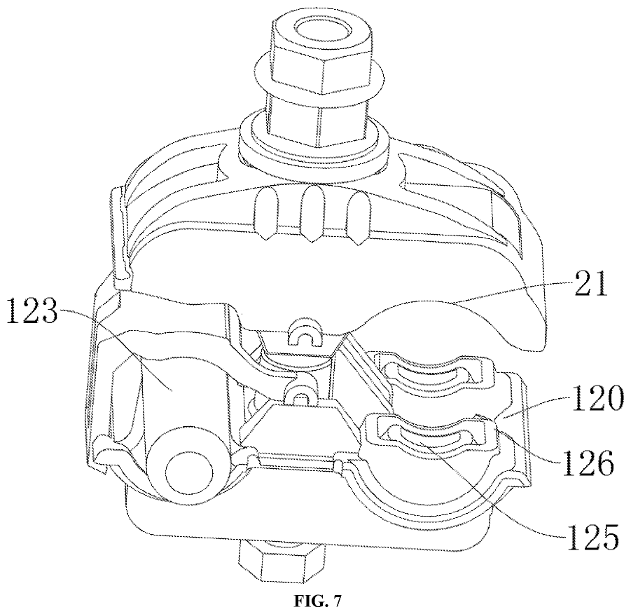

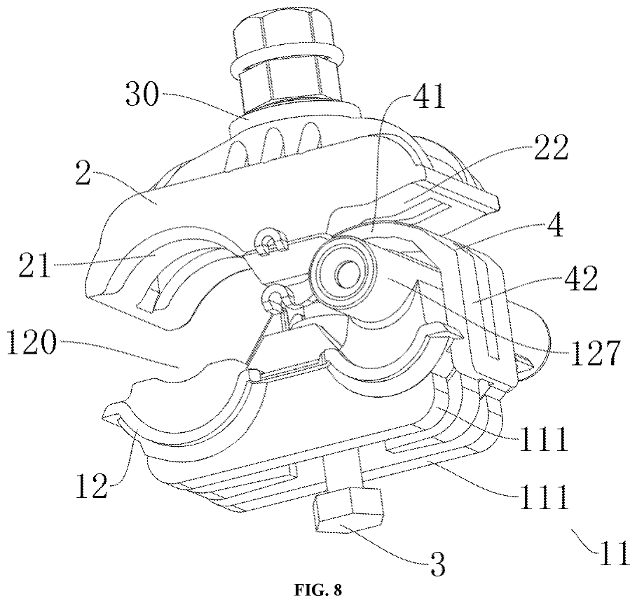

As shown in FIGS. 1-8, the insulation piercing connector comprises a first clamp body 1 and a second clamp body 2, the first clamp body 1 and the second clamp body 2 are arranged opposite to each other, a first cable 5 and a second cable 6 are located between the first clamp body 1 and the second clamp body 2, and the first cable 5 and the second cable 6 are respectively composed of an elongated conductor covered by an insulation layer, where the elongated conductor is made of a metal material, such as copper or aluminum.

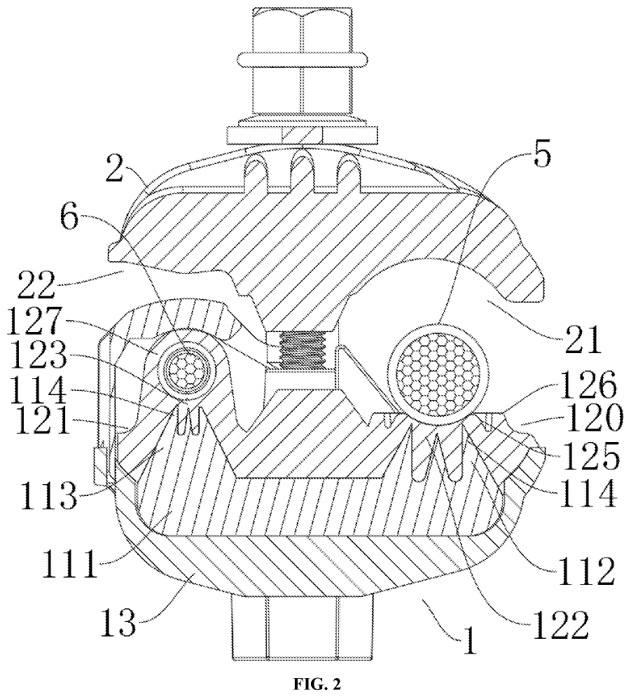

As shown in FIGS. 2-4, the first clamp body 1 comprises a conductive piercing structure 11 and an elastic insulator 12 that enables the conductive piercing structure 11 to be at least partially covered, where the conductive piercing structure 11 comprises two conductive piercing pieces 111 which are arranged apart from each other, the conductive piercing piece 111 each are provided with a first piercing portion 112 and a second piercing portion 113, the first piercing portion 112 and the second piercing portion 113 both extend toward the direction of the second clamp body 2, and three sharp portions 114 are formed at end portions; then the two conductive piercing pieces 111 are subject to injection molding and encapsulation by means of an elastic material (e.g., rubber), which results in a first elastic sealing portion 122 and a second elastic sealing portion 123 of the first clamp body 1, the first piercing portion 112 is covered by the first elastic sealing portion 122, and the second piercing portion 113 is covered by the second elastic sealing portion 123; the first piercing portion 112 faces and positionally corresponds to the first cable 5; the second piercing portion 113 faces and positionally corresponds to the second cable 6; and the conductive piercing pieces 111 are all made of a metal, such as tin; and outer surfaces of the first piercing portion 112 and the second piercing portion 113 of the tin conductive piercing pieces are clad with an aluminum layer, that is, the first piercing portion 112 and the second piercing portion 113 are made of tin-clad aluminum.

A corresponding fastener 3 is provided when the first clamp body 1 and the second clamp body 2 are assembled, and the first clamp body 1 and the second clamp body 2 are respectively mounted on the fastener 3 to be configured such that after the fastener 3 is fastened, both the first clamp body 1 and the second clamp body 2 have a clamping force to clamp the first cable 5 and the second cable 6; during continuous fastening of the fastener 3, the first piercing portion 112 passes through the first elastic sealing portion 122 and the insulation layer of the first cable 5 under the action of the clamping force and then interferes with the conductor of the first cable 5 to form conductive connection thereto, and the first elastic sealing portion 122 seals a periphery of an exposed portion of the first piercing portion 112; the second piercing portion 113 passes through the second elastic sealing portion 123 and the insulation layer of the second cable 6 under the action of the clamping force and then interferes with the elongated conductor of the second cable 6 to form conductive connection thereto, and the second elastic sealing portion 123 seals a periphery of an exposed portion of the second piercing portion 113; and a surface of the elastic insulator 12 facing the second clamp body 2 is also in close contact with a surface of the second clamp body 2 facing the first clamp body 1, so that the elastic insulator 12 and the second clamp body 2 are also sealed, so that a breakage of the insulation layer of the cable is closed to prevent water or vapor from entering through the breakage of the insulation layer of the cable.

As shown in FIGS. 2-4, the elastic insulator 12 is provided with a first clamping position 120, and the first elastic sealing portion 122 is located at the first clamping position 120; the second clamping body 2 is provided with a second clamping position 21, and the first clamping position 120 is arranged opposite to the second clamping position 21; the first elastic sealing portion 122 comprises an elastic clamping block 125 arranged protruding from the first clamping position 120, where the first clamping position 120 is arranged in a protruding state due to the sharp portion 114 of the first piercing portion 112, so that the elastic clamping block 125 is formed during the encapsulation; furthermore, the sharp portion 114 of the first piercing portion 112 is close to a cable contact surface of the elastic clamping block 125, and the first cable 5 is clamped between the cable contact surface of the elastic clamping block 125 and a cable contact surface of the second clamping position 21; since the cable contact surfaces of the elastic clamping block 125 and the second clamping position 21 are both arc-shaped concave surfaces, after the sharp portion 114 of the first piercing portion 112 passes through the cable contact surface of the elastic clamping block 125 and the insulation layer of the first cable 5, the two arc-shaped concave surfaces are in close contact with an outer peripheral wall of the insulation layer of the first cable 5; therefore, a gap between the cable contact surface of the elastic clamping block 125 and an outer wall of the insulation layer of the first cable 5 is filled, and a first resealing is performed at a breakage of the insulation layer of the first cable 5 after the branch clamp is mounted.

Further, the first clamping position 120 is provided with an elastic sealing ring 126 surrounding the elastic clamping block 125, and an end surface of the elastic sealing ring 126 interferes with the outer wall of the insulation layer of the first cable 5 so as to perform a second resealing on the breakage of the insulation layer of the first cable 5 after the branch clamp is mounted, where a height of the elastic clamping block 125 is a, a height of the elastic sealing ring 126 is b, a is greater than or equal to b, and a cable contact surface of the elastic sealing ring 126 is also an arc-shaped concave surface.

As shown in FIGS. 2-4, the elastic insulator 12 is provided with a third clamping position 121, the second elastic sealing portion 123 is located at the third clamping position 121, the second elastic sealing portion 123 is provided with a cable clamping sleeve 127 arranged protruding from the third clamping position 121, the cable clamping sleeve 127 is made of an elastic material, and the sharp portion 114 of the second piercing portion 113 is close to an inner wall surface of the cable clamping sleeve 127; at least one convex ring is formed on an inner wall of the cable clamping sleeve 127, and both ends of the cable clamping sleeve 127 are arranged closed and open respectively, where an inner wall of the open end forms a convex ring, and the inner wall of the cable clamping sleeve 127 has a plurality of convex rings; after the second cable 6 is inserted into the cable clamping sleeve 127, the convex ring is tightly tied to an outer wall of the second cable 6, and under the action of the clamping force of the first clamp body 1 and the second clamp body 2, the sharp portion 114 of the second piercing portion 113 passes through the inner wall surface of the cable clamping sleeve 127 and the insulation layer of the second cable 6; and the convex ring and the cable clamping sleeve are integrally formed of the same elastic material, so that the convex ring also has elasticity.

As shown in FIGS. 1-8, in order to easily pierce the insulation layer of the second cable 6, a piercing aid 4 is further provided on the branch clamp; the second clamp body 2 is provided with a fourth clamping position 22, and the third clamping position 121 and the fourth clamping position 22 are arranged opposite to each other; the piercing aid 4 comprises an aid body 41 and a sliding body 42 formed on the aid body 41, the aid body 41 is located between the cable clamping sleeve 127 and the fourth clamping position 22, and the sliding body 42 is slidingly connected to the first clamp body 1 so that the piercing aid 4 can slide in an axial direction of the fastener 3; and when the first clamp body 1 and the second clamp body 2 relatively close together, the aid body 41 fully squeezes the elastic cable clamping sleeve 127, so that the sharp portion 114 of the second piercing portion 113 can pass through the inner wall surface of the cable clamping sleeve 127.

As shown in FIGS. 1, 5 and 6, in order to ensure that displacement of the first clamp body 1 and the second clamp body 2 is relative translational motion, the first clamp body 1 further comprises a housing 13, the housing 13 covers the conductive piercing structure 11 and the elastic insulator 12, the housing 13 is provided with a first guide portion 124, and the second clamp body 2 is provided with a second guide portion 23. The first guide portion 124 is provided with an elongated guide groove 128 arranged parallel to an axis of the fastener 3, and the second guide portion 23 is arranged in the elongated guide groove 128, or the second guide portion 23 is provided with an elongated guide groove 128 arranged parallel to the axis of the fastener 3, and the first guide portion 124 is arranged in the elongated guide groove 128. The housing 13, the cable clamping sleeve 127, the elastic clamping block 125, the elastic sealing ring 126 and the elastic insulator 12 are integrally formed when the two conductive piercing pieces 111 are subject to injection molding and encapsulation; and where when the first guide portion 124 is provided with the elongated guide groove 128, the first guide portion is an elongated vertical structure and is arranged on the housing. The second guide portion 23 is arranged on the second clamp body 2, both the second guide portion and the third guide portion are bump structures, or when the second guide portion 23 is provided with the elongated guide groove 128, the second guide portion is an elongated vertical structure and is arranged on the second clamp body 2, the first guide portion 124 is arranged on the housing 1, and both the first guide portion and the third guide portion are bump structures.

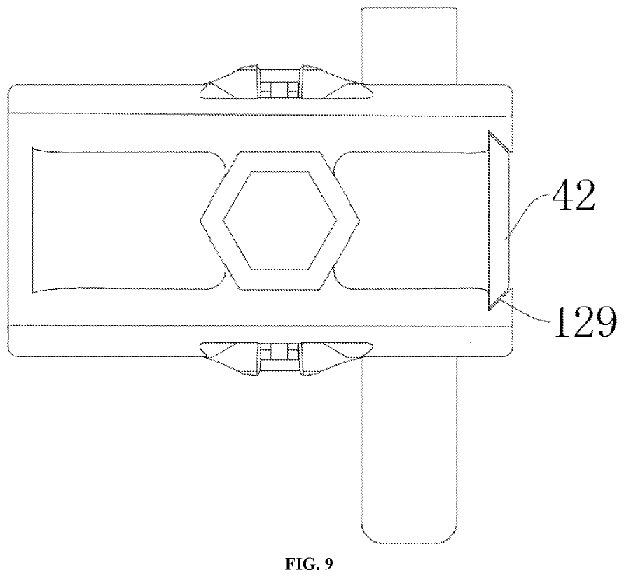

As shown in FIGS. 1 and 9, the sliding body is slidingly connected to the first clamp body 1 so that the piercing aid 4 can slide along the axis of the fastener 3, and the specific structure thereof is as follows: the elastic insulator 12 is provided with a trapezoidal channel 129, the sliding body 42 has a trapezoidal cross section, and the sliding body 42 is placed in the trapezoidal channel 129, or the aid body 41 is provided with a third guide portion 43, and the third guide portion 43 is placed in the elongated guide groove 128.

As shown in FIG. 2, the fastener 3 is a bolt, a screw of the bolt is simultaneously located in a perforation 10 which is arranged on the first clamp body 1 and the second clamp body 2 respectively for the screw of the bolt to pass through, a lower end of the screw of the bolt is threadedly connected to a limiting sleeve 32, the perforation 10 of the first clamp body 1 is in threaded connection with the screw of the bolt, an upper portion of the limiting sleeve 32 is placed in the perforation 10, a middle portion of the limiting sleeve 32 is sleeved with a limiting ring 31, the limiting ring 31 is limited by a middle limiting step 321 of the limiting sleeve 32, and a rear face of the second clamp body 2 is limited by the limiting ring 31 so as to prevent the second clamp body 2 from escaping from the lower end of the bolt, the perforation 10 of the second clamp body 2 is a tapered hole with a lower end diameter being smaller than an upper end diameter, and a lower portion of the limiting sleeve 32 is a truncated cone-shaped structure with a lower end diameter being smaller than an upper port diameter.

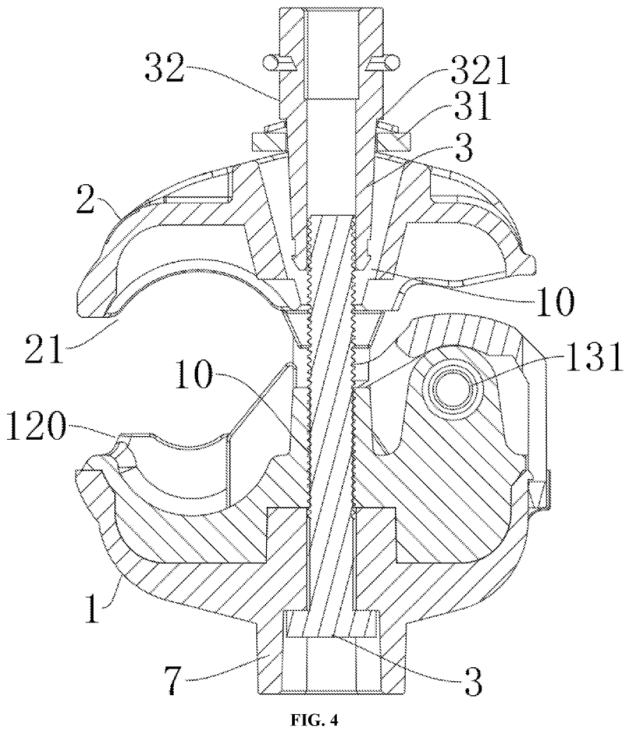

As shown in FIG. 4, an outer wall of the housing is provided with a positioning sleeve 7, the positioning sleeve 7 is in communication with the perforation of the first clamp body 1, and a central axis of the positioning sleeve 7 is arranged to coincide with a central axis of the perforation 10; a head portion of the bolt is placed in the positioning sleeve and is in a clearance fit; and an inner wall of the positioning sleeve and the head portion of the bolt are hexagonal structures so as to limit rotation of the fastener; at this moment, the limiting sleeve 32 is operated to rotate, so that the limiting sleeve 32 moves downwards, so that an inner wall of the tapered hole is adhered to an outer wall of the truncated cone of the limiting sleeve 32, and the limiting ring 31 interferes with the rear face of the second clamp body 2, so that a limiting member is driven to drive the second clamp body 2 to be displaced in the direction of the first clamp body 1, so that the first clamp body 1 and the second clamp body 2 are in a clamping state with the clamping force, and the fastener 3 is in a fastened state; and an outer diameter of the limiting ring is greater than the upper port diameter of the tapered hole, so the limiting ring can come into contact with the rear face of the second clamp body, so that when the limiting sleeve moves downwards, the second clamp body 2 can be driven to move downwards.

What is claimed is:

1. An insulation piercing connector, comprising:
a first clamp body,
a second clamp body, wherein the first clamp body and the second clamp body are arranged opposite to each other, the first clamp body comprises a conductive piercing structure, a first elastic sealing portion and a second elastic sealing portion, the conductive piercing structure is provided with a first piercing portion and a second piercing portion which extend toward the direction of the second clamp body, the first piercing portion is covered by the first elastic sealing portion, and the second piercing portion is covered by the second elastic sealing portion; and
a fastener, wherein the first clamp body and the second clamp body are respectively mounted on the fastener to be configured such that after the fastener is fastened, both the first clamp body and the second clamp body have a clamping force, such that the first piercing portion passes through the first elastic sealing portion, and the second piercing portion passes through the second elastic sealing portion.

2. The insulation piercing connector according to claim 1, wherein the first clamp body further comprises an elastic insulator that enables the conductive piercing structure to be at least partially covered, the first elastic sealing portion and the second elastic sealing portion are respectively formed on the elastic insulator, the elastic insulator is provided with a first clamping position, the first elastic sealing portion is located at the first clamping position, the second clamp body is provided with a second clamping position, the first clamping position is arranged opposite to the second clamping position, the first elastic sealing portion comprises an elastic clamping block arranged protruding from the first clamping position, and a sharp portion of the first piercing portion is close to a cable contact surface of the elastic clamping block.

3. The insulation piercing connector according to claim 2, wherein the first clamping position is provided with an elastic sealing ring surrounding the elastic clamping block, a height of the elastic clamping block is a, a height of the elastic sealing ring is b, and a is greater than or equal to b; and the cable contact surfaces of the elastic clamping block, the elastic sealing ring and the second clamping position are all arc-shaped concave surfaces.

4. The insulation piercing connector according to claim 2, wherein the elastic insulator is provided with a third clamping position, the second elastic sealing portion is located at the third clamping position, the second elastic sealing portion is provided with a cable clamping sleeve arranged protruding from the third clamping position, the cable clamping sleeve is made of an elastic material, a sharp portion of the second piercing portion is close to an inner wall surface of the cable clamping sleeve, at least one convex ring is formed on an inner wall of the cable clamping sleeve, and the cable clamping sleeve comprises at least one end opening.

5. The insulation piercing connector according to claim 4, further comprising a piercing aid, wherein the second clamp body is provided with a fourth clamping position, the third clamping position and the fourth clamping position are arranged opposite to each other, and the piercing aid is at least partially located between the cable clamping sleeve and the fourth clamping position.

6. The insulation piercing connector according to claim 5, wherein the piercing aid comprises an aid body and a sliding body formed on the aid body, the aid body is located between the cable clamping sleeve and the fourth clamping position, and the sliding body is slidingly connected to the first clamp body such that the piercing aid can slide in an axial direction of the fastener.

7. The insulation piercing connector according to claim 6, wherein the first clamp body further comprises a housing, the housing covers the conductive piercing structure and the elastic insulator, the housing is provided with a first guide portion, and the second clamp body is provided with a second guide portion; the first guide portion is provided with an elongated guide groove arranged parallel to an axis of the fastener, and the second guide portion is arranged in the elongated guide groove, or the second guide portion is provided with an elongated guide groove arranged parallel to the axis of the fastener, and the first guide portion is arranged in the elongated guide groove.

8. The insulation piercing connector according to claim 7, wherein the elastic insulator is provided with a trapezoidal channel, the sliding body has a trapezoidal cross section, and the sliding body is placed in the trapezoidal channel; the aid body is provided with a third guide portion, or the aid body is provided with a third guide portion, and the third guide portion is placed in the elongated guide groove.

9. The insulation piercing connector according to claim 1, wherein the conductive piercing structure comprises two conductive piercing pieces which are arranged apart from each other, and the conductive piercing pieces each are provided with the first piercing portion and the second piercing portion.

10. The insulation piercing connector according to claim 1, wherein the first clamp body and the second clamp body are respectively provided with a perforation for the fastener to pass through, the perforation of the first clamp body is threadedly connected with a threaded section of the fastener, a head portion of the fastener is seized with a seizing portion on the first clamp body to limit rotation of the fastener, a tail portion of the fastener is threadedly connected to a limiting member, the limiting member is in limiting fit with the second clamp body to be configured to operate the limiting member to drive the limiting member to displace the second clamp body in the direction of the first clamp body so that the first clamp body and the second clamp body are in a clamping state having the clamping force, and the fastener is in a fastened state.
